(19) United States
(12) Patent Application Publication
(10) Pub. No.: US 2023/0066809 A1
(43) Pub. Date: Mar. 2, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventors: SHUN LEE, TOKYO (JP); KOHEI URUSHIDO, TOKYO (JP); KAZUMI AOYAMA, TOKYO (JP); TAKAYOSHI TAKAYANAGI, TOKYO (JP); KENTA KAWAMOTO, TOKYO (JP); SHOHEI YAMAMOTO, TOKYO (JP)

(21) Appl. No.: 17/794,850

(22) PCT Filed: Jan. 7, 2021
(86) PCT No.: PCT/JP2021/000294

§ 371 Date: Jul. 22, 2022

(30) Foreign Application Priority Data
Jan. 30, 2020 (JP) 2020-014124

(51) Int. Cl. G08G 5/04; B64C 39/02; G05D 1/10; B64D 45/00

(52) U.S. Cl. CPC G08G 5/045; B64C 39/024; G05D 1/1064; B64D 45/00; B64C 2201/122

(57) ABSTRACT

A configuration is achieved in which collision risk information is received from a mobile device such as a drone, a modified path with a low collision risk is generated, and movement according to the modified path is performed. Existence of a second mobile device or pedestrian exposed to a collision risk is checked on the basis of collision risk information received from the mobile device such as a drone, and in a case where the existence of the second mobile device or pedestrian exposed to the collision risk is confirmed, collision risk information received from a first mobile device or modified safe circuit information is transmitted to the second mobile device exposed to the collision risk, or transmitted to a user terminal held by the pedestrian exposed to the collision risk. The collision risk information received from the mobile device such as a drone is risk information with which a collision risk corresponding to a three-dimensional spatial position can be analyzed.

### TECHNICAL FIELD

The present disclosure relates to an information processing device, an information processing method, and a program. More specifically, the present technology relates to an information processing device, an information processing method, and a program that calculate a collision risk of a mobile device such as a drone for example, and perform collision avoidance control according to the calculated collision risk.

### BACKGROUND ART

In recent years, utilization of drones, which are small flight vehicles, has rapidly increased. For example, a camera mounted on a drone is utilized for processing of capturing an image of a landscape on ground from above, or the like. Furthermore, utilization of drones for package deliveries is also planned, and various experiments have been conducted.

At present, in many countries, it is required to control a flight of a drone by operating a controller under supervision of a human, that is, within a range visible to the human. However, it is estimated that, in the future, there will be utilized many autonomous-flight drones that do not require visual supervision of a human, that is, drones that autonomously fly from a departure point to a destination.

Such an autonomous-flight drone flies from a departure point to a destination by utilizing, for example, communication information with a control center or GPS position information.

It is expected that, in the future, possibilities of a collision between drones and of a crash of a drone increase as the number of drones operated by the controller and autonomous-flight drones increases.

There is a possibility of causing a big accident if a drone falls in an area where a large number of cars and people come and go, such as an urban area.

Note that, for example, Patent Document 1 (Japanese Patent Application Laid-Open No. 2019-039875) and Patent Document 2 (Japanese Patent Application Laid-Open No. 2019-113467) are conventional technologies that disclose a technology related to a setting of a flight path of a drone or calculation of a crash risk.

Patent Document 1 discloses a method for setting a flight path, and discloses a configuration in which a score based on safety is calculated for each of a plurality of flight path candidates and, a safest flight path is selected by utilizing the calculated scores.

Patent Document 2 discloses a configuration in which area information and flight condition information of a flight path of a drone are collected, and a risk of a drone crash is calculated.

However, conventional technologies including these documents do not sufficiently disclose specific collision-risk calculation corresponding to a three-dimensional position or collision avoidance control according to a collision risk corresponding to each position.

### CITATION LIST

### Patent Document

### Patent Document 1: Japanese Patent Application Laid-Open No. 2019-039875

### Patent Document 2: Japanese Patent Application Laid-Open No. 2019-113467

### SUMMARY OF THE INVENTION

### Problems to be Solved by the Invention

The present disclosure has been made in view of the above-described problems, for example, and an object thereof is to provide an information processing device, an information processing method, and a program that calculate a crash or collision risk of a mobile device such as a drone, and perform collision avoidance control according to the calculated risk.

### Solutions to Problems

A first aspect of the present disclosure is

an information processing device including a data processing unit that

checks, on the basis of collision risk information received from a first mobile device, existence of a second mobile device exposed to a collision risk, and,

in a case where the existence of the second mobile device exposed to the collision risk is confirmed,

transmits, to the second mobile device exposed to the collision risk, the collision risk information received from the first mobile device.

Moreover, a second aspect of the present disclosure is

an information processing device mounted on a drone,

in which a data processing unit

generates collision risk information corresponding to each three-dimensional spatial position as collision risk information of the drone, and

transmits the generated collision risk information to an external device.

Moreover, a third aspect of the present disclosure is

an information processing device mounted on a drone, the information processing device including a data processing unit that

generates, on the basis of collision risk information received from an uncontrollable drone, a modified safe flight path with a low collision risk, and

executes flight control according to the generated modified flight path.

Moreover, a fourth aspect of the present disclosure is

an information processing method executed in an information processing device, the information processing method including, by a data processing unit,

checking, on the basis of collision risk information received from a first mobile device, existence of a second mobile device exposed to a collision risk, and,

in a case where the existence of the second mobile device exposed to the collision risk is confirmed,

transmitting, to the second mobile device exposed to the collision risk, the collision risk information received from the first mobile device.

Moreover, a fifth aspect of the present disclosure is

an information processing method executed in an information processing device mounted on a drone, the information processing method including,

by a data processing unit,

generating collision risk information corresponding to each three-dimensional spatial position as collision risk information of the drone, and

transmitting the generated collision risk information to an external device.

Moreover, a sixth aspect of the present disclosure is

an information processing method executed in an information processing device mounted on a drone, the information processing method including,

by a data processing unit,

generating, on the basis of collision risk information received from an uncontrollable drone, a modified safe flight path with a low collision risk, and

executing flight control according to the generated modified flight path.

Moreover, a seventh aspect of the present disclosure is

a program causing information processing to be executed in an information processing device, the program causing a data processing unit to execute processing of

checking, on the basis of collision risk information received from a first mobile device, existence of a second mobile device exposed to a collision risk, and,

in a case where the existence of the second mobile device exposed to the collision risk is confirmed,

transmitting, to the second mobile device exposed to the collision risk, the collision risk information received from the first mobile device.

Moreover, an eighth aspect of the present disclosure is

a program causing information processing to be executed in an information processing device mounted on a drone, the program causing a data processing unit to execute processing of

generating collision risk information corresponding to each three-dimensional spatial position as collision risk information of the drone, and

transmitting the generated collision risk information to an external device.

Note that a program according to the present disclosure is, for example, a program that can be provided by a storage medium or communication medium provided in a computer-readable format to an information processing device or computer system capable of executing various program codes. By providing such a program in the computer-readable format, processing according to the program is achieved on the information processing device or the computer system.

Still other objects, features, and advantages of the present disclosure will become apparent from more detailed description based on embodiments of the present disclosure described below and the accompanying drawings. Note that, in the present specification, a system is a logical set configuration of a plurality of devices, and is not limited to a system in which devices of respective configurations are in the same housing.

According to a configuration of an embodiment according to the present disclosure, a configuration is achieved in which collision risk information is received from a mobile device such as a drone, a modified path with a low collision risk is generated, and movement according to the modified path is performed.

Specifically, for example, existence of a second mobile device or pedestrian exposed to a collision risk is checked on the basis of collision risk information received from the mobile device such as a drone, and in a case where the existence of the second mobile device or pedestrian exposed to the collision risk is confirmed, collision risk information received from the first mobile device or modified safe circuit information is transmitted to the second mobile device exposed to the collision risk, or transmitted to a user terminal held by the pedestrian exposed to the collision risk. The collision risk information received from the mobile device such as a drone is risk information with which a collision risk corresponding to a three-dimensional spatial position can be analyzed.

With this configuration, a configuration is achieved in which collision risk information is received from a mobile device such as a drone, a modified path with a low collision risk is generated, and movement according to the modified path is performed.

Note that the effects described herein are only examples and are not limited thereto, and additional effects may also be present.

### BRIEF DESCRIPTION OF DRAWINGS

FIG. 1 is a diagram describing an example of processing executed by an information processing device according to the present disclosure.

FIG. 2 is a diagram describing an example of processing executed by the information processing device according to the present disclosure.

FIG. 3 is a diagram describing an example of processing executed by the information processing device according to the present disclosure.

FIG. 4 is a diagram describing an example of processing executed by the information processing device according to the present disclosure.

FIG. 5 is a diagram describing an example of processing executed by the information processing device according to the present disclosure.

FIG. 6 is a diagram describing generation of a modified flight path and flight processing according to the modified flight path.

FIG. 7 is a diagram describing generation of a modified flight path and flight processing according to the modified flight path.

FIG. 8 is a diagram describing an example of processing utilizing a drone management server.

FIG. 9 is a diagram describing an example of processing utilizing the drone management server.

FIG. 10 is a diagram describing an example of processing of updating a modified flight path.

FIG. 11 is a diagram describing an example of warning notification processing for a user terminal.

FIG. 12 is a diagram describing an example of warning notification processing for the user terminal.

FIG. 13 is a diagram describing an example of warning notification processing for the user terminal.

FIG. 14 is a diagram describing an example of warning notification processing for the user terminal.

FIG. 15 is a diagram describing an example of warning notification processing for the user terminal.

FIG. 16 is a diagram describing an example of warning notification processing for a controller.

FIG. 17 is a diagram describing an example of warning notification processing for the controller.

FIG. 18 is a diagram illustrating a flowchart describing a processing sequence executed by an information processing device of an uncontrollable drone.

FIG. 19 is a diagram illustrating a flowchart describing a processing sequence executed by an information processing device of a controllable drone.

FIG. 20 is a diagram illustrating a flowchart describing a processing sequence executed by the drone management server.

FIG. 21 is a diagram illustrating a flowchart describing a processing sequence executed by the drone management server.

FIG. 22 is a diagram illustrating a flowchart describing a processing sequence executed by the user terminal or the controller.

FIG. 23 is a diagram illustrating a flowchart describing a processing sequence executed by the user terminal or the controller.

FIG. 24 is a diagram describing a configuration example of the information processing device according to the present disclosure.

FIG. 25 is a diagram describing a hardware configuration example of the information processing device according to the present disclosure.

### MODE FOR CARRYING OUT THE INVENTION

Hereinafter, an information processing device, information processing method, and program according to the present disclosure will be described in detail with reference to the drawings. Note that the description will be made according to the following items.

1. Predicted flight path estimation processing and collision risk calculation processing executed by information processing device according to present disclosure

2. Collision avoidance control processing executed by information processing device according to present disclosure

3. Embodiment for avoiding collision on ground

4. Embodiment for displaying warning information or the like on controller of controllable drone

5. Sequences of processing executed by information processing device according to present disclosure

6. Configuration example of information processing device

7. Conclusion of configuration according to present disclosure

[1. Predicted Flight Path Estimation Processing and Collision Risk Calculation Processing Executed by Information Processing Device According to Present Disclosure]

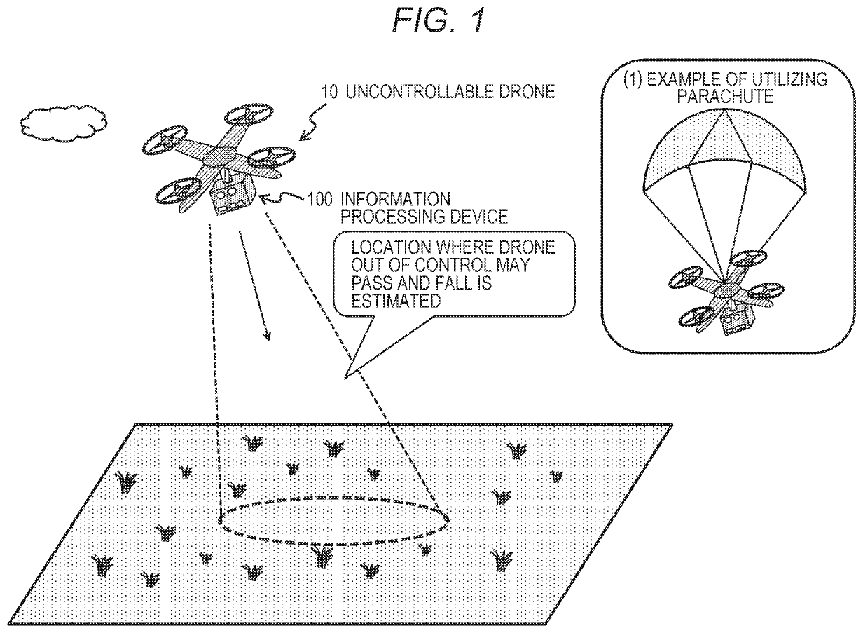

First, predicted flight path estimation processing and collision risk calculation processing executed by the information processing device according to the present disclosure will be described with reference to FIG. 1 and subsequent drawings.

Note that, in the following description, a mobile object to be a target of processing by the information processing device according to the present disclosure will be described as a drone. However, the information processing device can be used in a configuration in which processing is performed, not limited to for a drone, but for another mobile object, for example, a robot or an autonomous driving vehicle.

FIG. 1 illustrates a configuration example in which an information processing device 100 is mounted on an uncontrollable drone 10.

As described above, currently, in many countries, it is required to control a flight of a drone by operating a controller under supervision of a human, that is, within a range visible to the human. However, it is predicted that, in the future, there will be utilized autonomous-flight drones that do not require visual supervision of a human, that is, drones that autonomously fly from a departure point to a destination. Such an autonomous-flight drone flies from a departure point to a destination by utilizing, for example, communication information with a control center or GPS position information.

Regardless of a drone of which flight control is operated with a controller under visual supervision of a human, or an autonomous-flight drone, the drone may fall into an uncontrollable state due to a communication failure or a broken apparatus.

In a case where the drone is in such an uncontrollable state, the information processing device 100 executes processing of predicting a flight area through which the uncontrollable drone 10 passes, or a crash point of the uncontrollable drone 10.

As soon as it is found that the drone will crash or land in the uncontrollable state, the information processing device 100 estimates a location where the drone will land (crash) and a flight path to the crash point.

Note that the information processing device 100 estimates the flight path to the crash point by utilizing information acquired by a sensor mounted on the drone 10.

For example, a position, flight direction, speed, flight state, surrounding environment information, and the like of the drone are acquired from the sensor, and these pieces of acquired information are analyzed to estimate the flight path to the crash point.

Note that, in the processing of estimating the flight path to the crash point, observation information from another mobile object such as another drone can be used as reference information.

The uncontrollable drone 10 illustrated in FIG. 1 may crash as is, or may land by opening a parachute as illustrated in FIG. 1 (1).

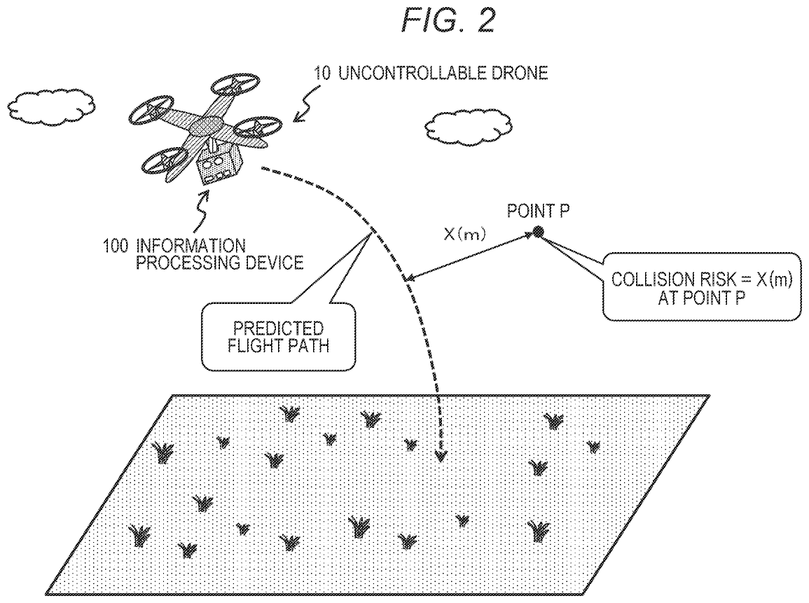

An example of collision risk calculation processing by the information processing device 100 according to the present disclosure will be described with reference to FIG. 2.

The information processing device 100 estimates a collision risk by using information detected by the sensor mounted on the uncontrollable drone 10.

Note that, in the following description, “collision” includes not only a collision with another object in the air or on ground but also a crash that is collision with the ground.

The information processing device 100 calculates the collision risk in the air or on the ground by using the information detected by the sensor mounted on the uncontrollable drone 10.

The information processing device 100 calculates the collision risk on the basis of a predicted flight path of the uncontrollable drone 10 indicated by the dotted line in FIG. 2, flight state information such as a current position, speed, acceleration, moving direction, or parachute use information of the uncontrollable drone 10, or environmental information such as wind speed or wind direction.

Note that information for calculating a collision risk is acquired from the sensor mounted on the uncontrollable drone 10.

FIG. 2 illustrates an example in which the collision risk is represented by using a separation distance from the predicted flight path of the uncontrollable drone 10.

For example, a point P illustrated in FIG. 2 is one point P in a three-dimensional space. The point P is a point at a position of the separation distance=X (m) that is from the predicted flight path of the uncontrollable drone 10.

The collision risk at the point P is calculated as

Collision risk=X (m).

In this form of presentation of the collision risk,

collision risk=0 (m) is a maximum collision risk, which means that a collision probability is high.

Meanwhile, the larger a value of the collision risk, that is, the larger a value of the separation distance from the predicted flight path, the lower the collision probability.

The information processing device 100 of the uncontrollable drone 10 calculates a separation distance from the predicted flight path of the uncontrollable drone 10 as a collision risk corresponding to each point in the three-dimensional space.

That is, a separation distance from the predicted flight path of the uncontrollable drone 10 is calculated for each point (x, y, z) in the three-dimensional space, and the separation distances are calculated as collision risks at the respective points (x, y, z) in the three-dimensional space.

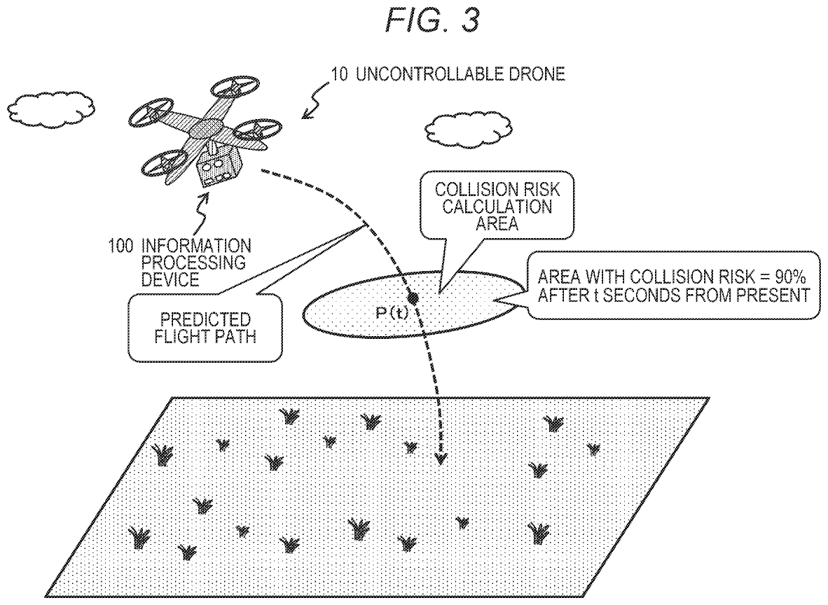

Another example of collision risk calculation processing executed by the information processing device 100 will be described with reference to FIG. 3.

The example illustrated in FIG. 3 is an example of calculating the collision risk in a unit of area including the predicted flight path of the uncontrollable drone 10.

A risk calculation area illustrated in FIG. 3 is an area including one point P (t) of the predicted flight path of the uncontrollable drone 10.

The point P (t) corresponds to an estimated position of the uncontrollable drone 10 after t seconds from a current time.

The risk calculation area illustrated in FIG. 3 indicates that the uncontrollable drone 10 will be present with a probability of 90% at somewhere in the area after t seconds from the current time.

Note that the information processing device 100 calculates a collision probability at each spatial position at each time with processing using a sequential Bayesian filter such as a Kalman filter, for example. By using a Bayesian filter, a position of an airframe after t seconds can be estimated from a locus up to the present (past position information).

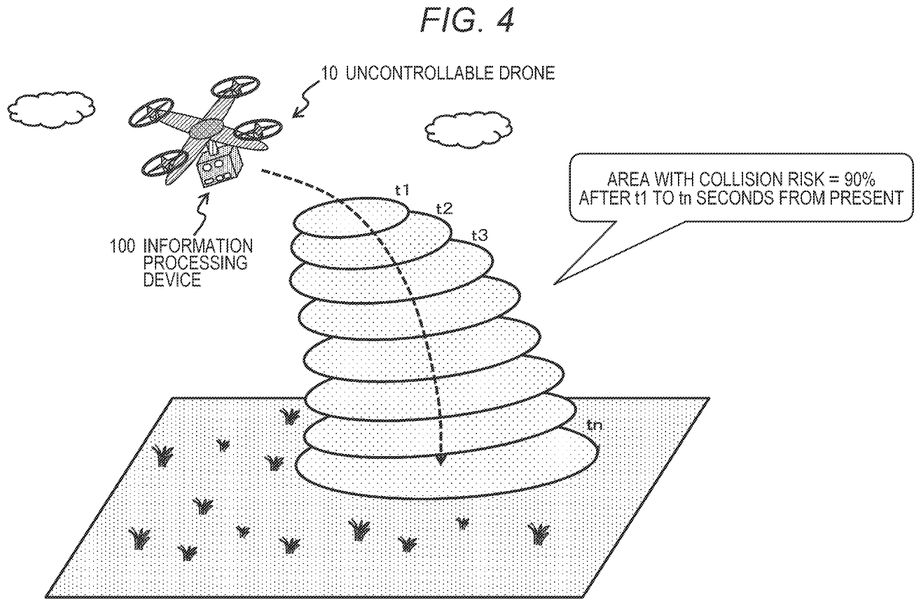

FIG. 4 illustrates an example of processing of estimating, by using the sequential Bayesian filter, an airframe position corresponding to a time elapsed from the current time, and of calculating a collision probability at each spatial position around the estimated position.

FIG. 4 is a diagram illustrating areas calculated on the basis of a result of estimation of airframe positions after t1 to tn seconds from the current time. The airframe will be present with a probability of 90% at somewhere at each spatial position in the areas around the estimated airframe position at each time.

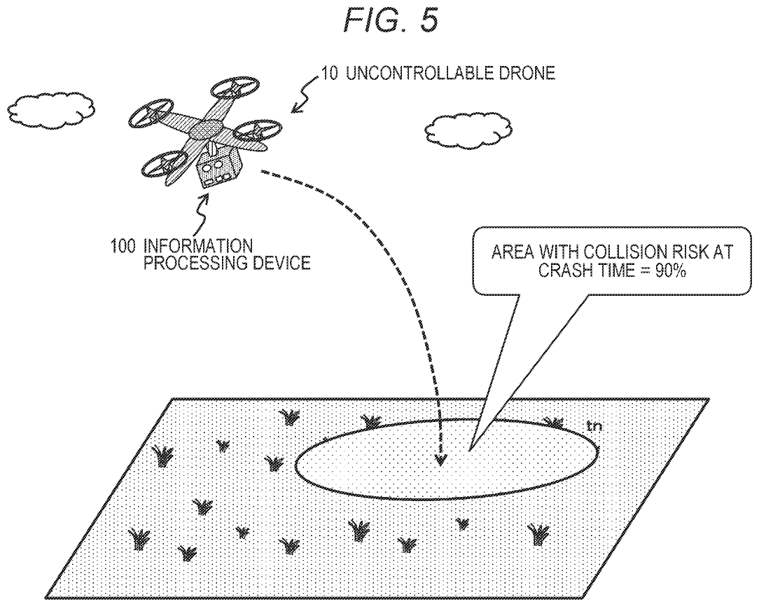

Furthermore, FIG. 5 is a diagram illustrating an area with Collision probability=90% on the ground at a crash time in a ground arrival time (after tn seconds from the present).

Thus, because a position of the airframe after t seconds can be estimated by using the sequential Bayesian filter, for example, it is possible to estimate a position where the airframe does not collide with a drone with a probability of 90% after t seconds, a location where the airframe does not crash with a probability of 90%, and the like.

Note that, in a case where the Kalman filter or an extended Kalman filter is applied as the Bayesian filter, the information processing device 100 generates “state data” including multivariate normal distribution data as a probability distribution model including each piece of information such as flight state information such as a current position, speed, acceleration, moving direction, and self-position estimation value of a drone, and further including environmental information such as wind speed and a wind direction, and performs processing of updating the “state data” by using the Kalman filter or the extended Kalman filter to estimate the position of the drone.

The “state data” includes multivariate normal distribution data including a variance-covariance matrix based on each piece of information such as flight state information such as the current position, speed, acceleration, moving direction, and self-position estimation value of the drone, and environmental information such as wind speed and wind direction.

The variance-covariance matrix is a matrix including [variance] of specific state values, such as each piece of information such as flight state information such as the current position, speed, acceleration, moving direction, and self-position estimation value of the drone, and environmental information such as wind speed and wind direction, and [covariance] corresponding to correlation information of a combination of different state values of each of these state values.

The information processing device 100 executes processing of calculating a collision probability (collision probability) at each time and each spatial position by using state data including multivariate normal distribution data including a variance-covariance matrix.

[2. Collision Avoidance Control Processing Executed by Information Processing Device According to Present Disclosure]

Next, collision avoidance control processing executed by the information processing device according to the present disclosure will be described.

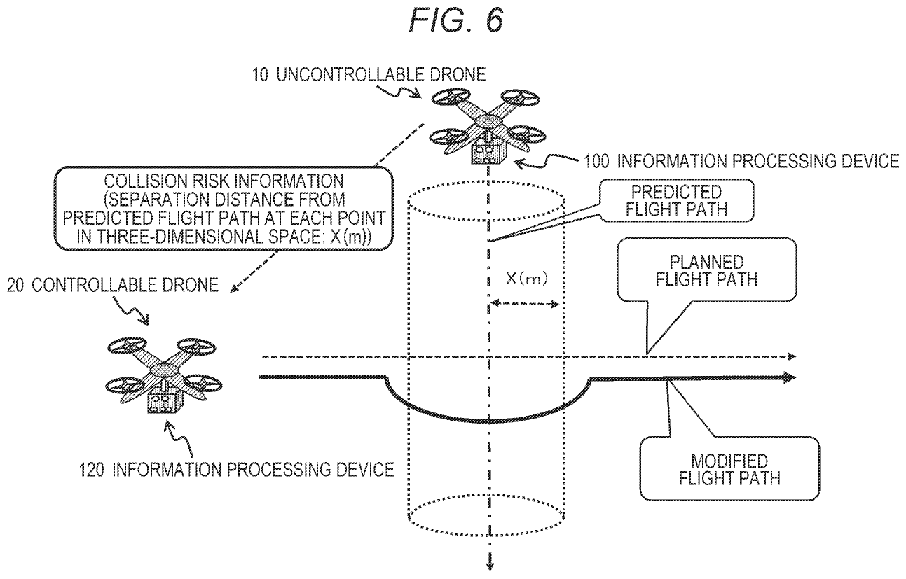

FIG. 6 illustrates an example of the collision avoidance control processing executed by the information processing device according to the present disclosure.

FIG. 6 illustrates an uncontrollable drone 10 and a controllable drone 20.

The uncontrollable drone 10 is the uncontrollable drone 10 described with reference to FIGS. 1 to 5, and may crash out of control.

Meanwhile, the controllable drone 20 is a drone on which flight control can be performed. The controllable drone 20 is a drone controlled by a controller operated by a user or an autonomous-flight drone.

An information processing device 120 according to the present disclosure is also mounted on the controllable drone 20.

The information processing device 100 of the uncontrollable drone 10 calculates a collision risk as described with reference to FIGS. 1 to 5.

The information processing device 100 of the uncontrollable drone 10 transmits collision risk information including the calculated collision risk to the controllable drone 20.

The information processing device 120 of the controllable drone 20 changes a planned flight path to a modified flight path on the basis of the collision risk information received from the uncontrollable drone 10.

That is, in a case where the planned flight path is a path that passes through an area with a high collision risk, a new modified flight path avoiding the area is generated, and a flight according to the generated modified flight path is performed.

With this flight path modification processing, the controllable drone 20 can fly while avoiding a collision with the uncontrollable drone 10.

Note that the example illustrated in FIG. 6 is an example of processing utilizing the collision risk information described above with reference to FIG. 2.

That is, the information processing device 100 of the uncontrollable drone 10 calculates a separation distance from the predicted flight path of the uncontrollable drone 10 as a collision risk corresponding to each point in the three-dimensional space.

That is, a separation distance from the predicted flight path of the uncontrollable drone 10 is calculated for each point (x, y, z) in the three-dimensional space, and the separation distances are calculated as collision risks at the respective points (x, y, z) in the three-dimensional space.

The information processing device 100 of the uncontrollable drone 10 transmits, to the controllable drone 20, the calculated collision risk, that is, the separation distance information from the predicted flight path of the uncontrollable drone 10 at each point (x, y, z) in the three-dimensional space.

The information processing device 120 of the controllable drone 20 generates a modified flight path on the basis of the collision risk information received from the uncontrollable drone 10, that is,

separation distance information from the predicted flight path of the uncontrollable drone 10 at each point (x, y, z) in the three-dimensional space, and flies according to the generated modified flight path.

For example, a modified flight path for flying at a position Xm or more away from the predicted flight path of the uncontrollable drone 10 is generated, and a flight according to the generated modified flight path is performed.

With this flight path modification processing, the controllable drone 20 can fly while avoiding a collision with the uncontrollable drone 10.

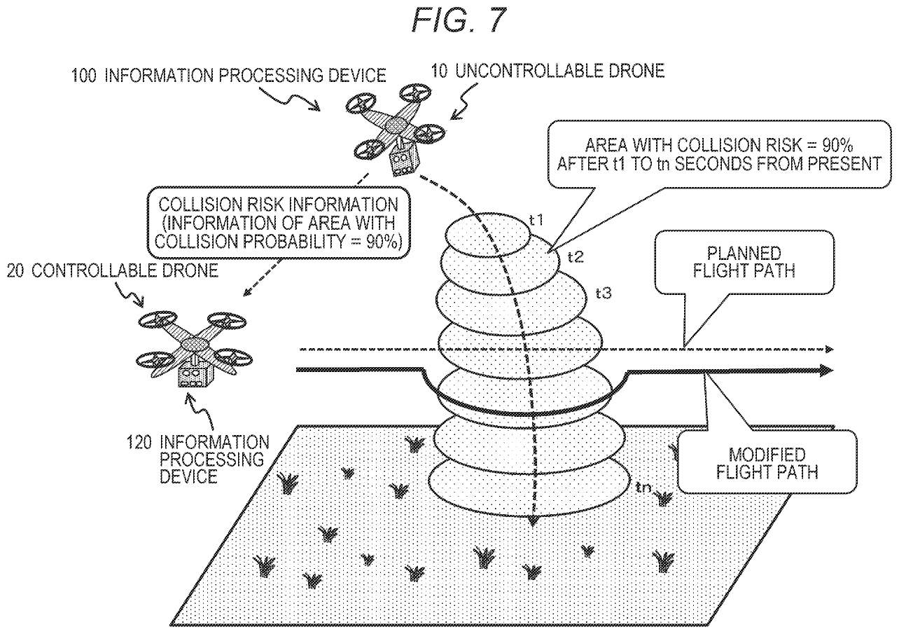

Next, an example of processing utilizing the collision risk information described above with reference to FIGS. 3 to 5 will be described with reference to FIG. 7.

In the example illustrated in FIG. 7, the information processing device 100 of the uncontrollable drone 10 calculates a collision probability at each spatial position at each time with Bayesian inference processing using a sequential Bayesian filter such as a Kalman filter, for example. As described above, by using the Bayesian filter, a position of an airframe after t seconds can be estimated from a locus up to the present (past position information).

A plurality of elliptical areas illustrated in FIG. 7 is areas calculated on the basis of a result of estimation of airframe positions after t1 to tn seconds from the current time, and is areas in which the airframe will be present with a probability of 90% at somewhere at each spatial position in the elliptical areas around the estimated airframe position at each time.

The information processing device 100 of the uncontrollable drone 10 generates this area information, that is, time-series information of the areas in which a collision probability is 90%, as collision risk information, and transmits the generated collision risk information to the controllable drone 20.

The information processing device 120 of the controllable drone 20 analyzes the collision risk information received from the uncontrollable drone 10, that is, the time-series information of the areas in which the probability of collision is 90%, and changes a planned flight path to a modified flight path.

That is, a new modified flight path that does not pass through the areas in which the probability of collision is 90% is generated, and a flight is performed according to the generated modified flight path.

With this flight path modification processing, the controllable drone 20 can fly while avoiding a collision with the uncontrollable drone 10.

Note that, although a configuration in which the collision risk information generated by the uncontrollable drone 10 is directly transmitted to the controllable drone 20 has been described in the embodiment described with reference to FIGS. 6 and 7, transmission/reception processing of the collision risk information may be performed, for example, via a server, other than by direct communication between drones.

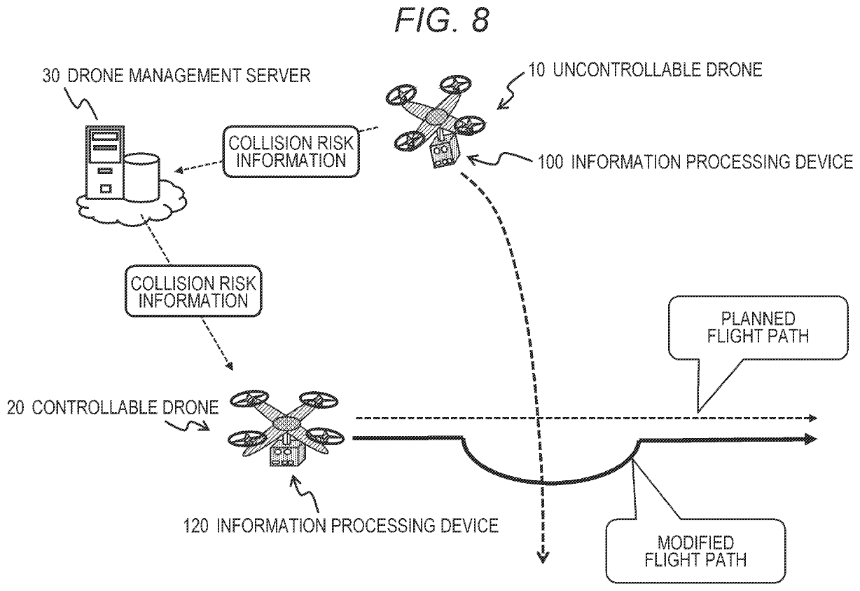

A configuration in a case where this processing is performed will be described with reference to FIG. 8.

For example, as illustrated in FIG. 8, the uncontrollable drone 10 transmits the collision risk information generated by the uncontrollable drone 10 to a drone management server 30.

To the controllable drone 20 flying near the uncontrollable drone 10, the drone management server 30 transfers the collision risk information received from the uncontrollable drone 10.

Thus, the collision risk information may be transferred via the drone management server 30.

Moreover, the drone management server 30 may be configured to receive collision risk information generated by the uncontrollable drone 10, generate a modified safe flight path available to the controllable drone 20 on the basis of the received collision risk information, and transmit the modified flight path to the controllable drone 20.

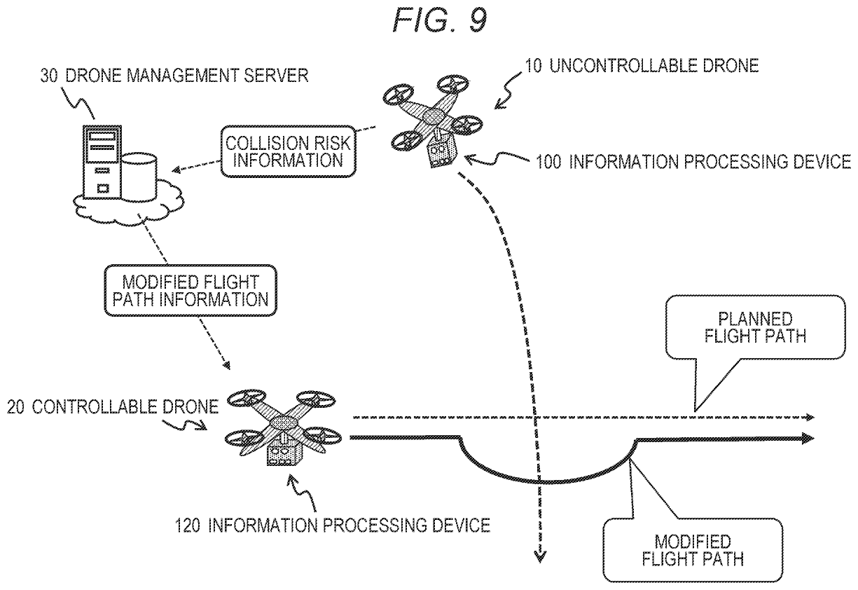

This configuration example will be described with reference to FIG. 9.

As illustrated in FIG. 9, the uncontrollable drone 10 transmits the collision risk information generated by the uncontrollable drone 10 to the drone management server 30.

The drone management server 30 receives the collision risk information generated by the uncontrollable drone 10, and generates a modified safe flight path available to the controllable drone 20 on the basis of the received collision risk information.

Note that, it is assumed that the drone management server 30 acquires planned flight path information from the controllable drone 20 in advance.

In a case where it is judged that the planned flight path of the controllable drone 20 is near the predicted flight path of the uncontrollable drone 10 and therefore is a path with a high collision probability, the drone management server 30 generates a modified safe flight path available to the controllable drone 20, and transmits the modified safe flight path to the controllable drone 20.

Upon receiving the modified flight path from the drone management server 30, the controllable drone 20 stops flying according to the planned flight path and flies according to the modified flight path received from the drone management server 30.

With this flight path modification processing, the controllable drone 20 can fly while avoiding a collision with the uncontrollable drone 10.

The drone management server 30 may further be configured to transmit an emergency stop command, an emergency landing command, or the like to the controllable drone 20.

Note that there may be a case where the predicted flight path of the uncontrollable drone 10 or a surrounding area thereof with a high collision probability is changed with time.

The uncontrollable drone 10 sequentially generates and updates collision risk information, and transmits last updated collision risk information to the controllable drone 20 or the drone management server 30.

With this arrangement, the controllable drone 20 always generates a new modified flight path with a low collision probability on the basis of the last updated collision risk information.

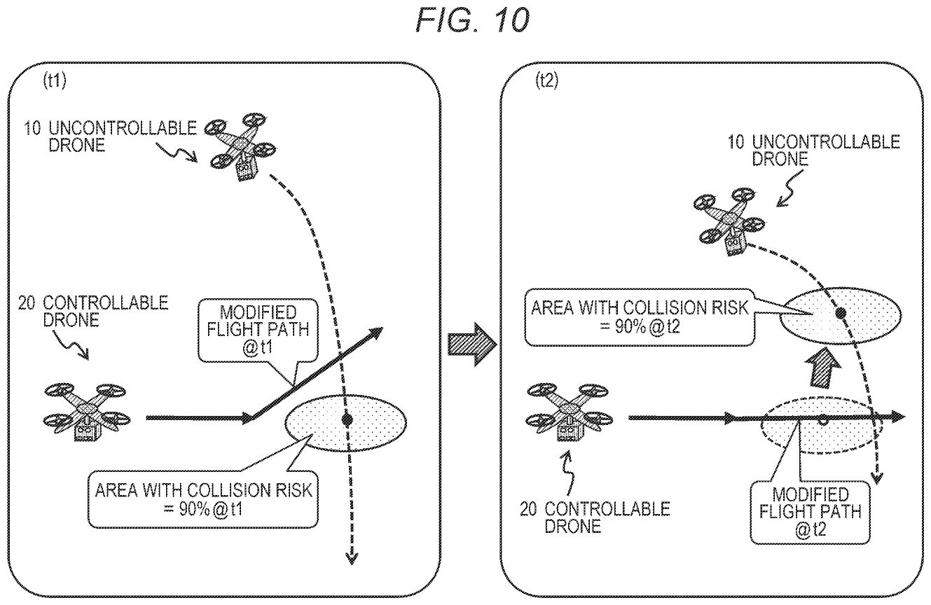

A specific example will be described with reference to FIG. 10.

FIG. 10 illustrates an example of processing of updating a modified flight path at time (t1) and time (t2) immediately after the time (t1).

At the time (t1), it is assumed that an area with collision risk=90% calculated by the uncontrollable drone 10 is an “area with collision risk=90% @t1” illustrated in the drawing.

At this point, the controllable drone 20 generates, on the basis of the collision risk information calculated by the uncontrollable drone 10, a “modified flight path @ t1” avoiding the “area with collision risk=90% @ t1”, and starts a flight according to the generated “modified flight path @ t1”.

However, at the time (t2), it is assumed that the area with collision risk=90% calculated by the uncontrollable drone 10 is changed to an “area with collision risk=90% @ t2” illustrated in the drawing.

In this case, the controllable drone 20 generates, on the basis of the collision risk information updated by the uncontrollable drone 10, a new “modified flight path @ t2” avoiding the “area with collision risk=90% @ t2”, and starts a flight according to the generated new “modified flight path @ t2”.

Thus, the uncontrollable drone 10 always provides last updated collision risk information, and the controllable drone 20 generates a new modified flight path with a low collision probability on the basis of the last updated collision risk information, and flies.

With this processing, the controllable drone 20 can fly safely with a reduced probability of collision.

[3. Embodiment for Avoiding Collision on Ground]

Next, an embodiment for avoiding a collision on the ground will be described.

The uncontrollable drone 10 finally crashes into the ground, and if there is a human or car on the ground, there is a possibility of colliding with the human or the car.

The processing example described below is an embodiment in which an estimated crash location information of the uncontrollable drone 10 is provided to a user terminal, such as a smartphone owned by a human or a communication terminal mounted on a car for example, and processing of providing a notification to change a moving path of the human or the car is executed.

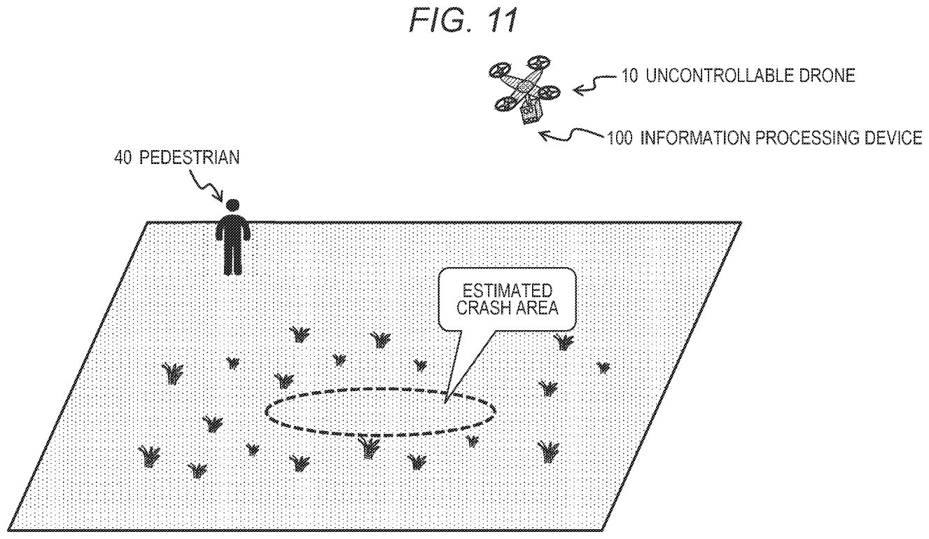

For example, as illustrated in FIG. 11, it is assumed that there is a pedestrian 40 on the ground, and an “estimated crash area” of the uncontrollable drone 10 exists on a planned path of the pedestrian 40.

The “estimated crash area” illustrated in FIG. 11 corresponds to, for example, the area with collision risk=90% described above with reference to FIG. 5.

In such a case, the information processing device 100 of the uncontrollable drone 10 broadcasts warning information to a communication terminal, which is a smartphone for example, near the “estimated crash area”. Specifically, for example, the warning information is transmitted to a user terminal in the estimated crash area or in a range of about 30 m around the estimated crash area.

The warning information indicating that there is a possibility of a drone crash is displayed on the user terminal, such as a smartphone, that has received the warning information, and an alarm is output.

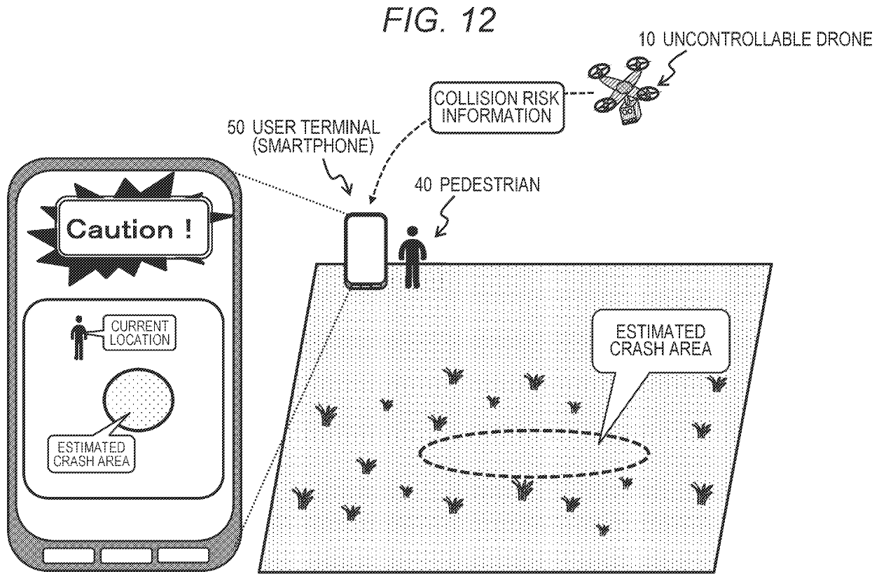

For example, warning information as illustrated in FIG. 12 is displayed on a user terminal 50. Note that it is assumed that an application (program) that analyzes received information in response to reception of collision risk information from the drone, and generates display data based on an analysis result is installed in advance on the user terminal 50.

For example, the pedestrian 40 illustrated in FIG. 12 can check the warning information displayed on the user terminal 50, recognize that there is a possibility that a drone may crash nearby, and take evacuation action so as to move away from the displayed estimated crash area.

Note that, although the above description is an example of utilizing a smartphone owned by the pedestrian 40, it is also possible to display information similar to display information of the user terminal 50 as illustrated in FIG. 12 on a communication terminal mounted on a car, for example. In this case, a driver of the car can check the warning information displayed on the communication terminal of the car, recognize that there is a possibility that a drone may crash nearby, and take evacuation action so as to move away from the displayed estimated crash area.

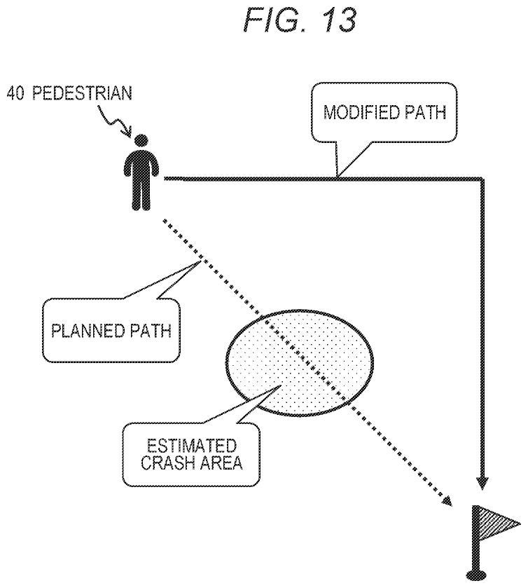

Note that, moreover, as illustrated in FIG. 13, in a case where the planned path on which the pedestrian 40 or the car is about to pass through the estimated crash area is known, processing of notifying the pedestrian 40 or the car of a modified path avoiding the estimated crash area may be performed.

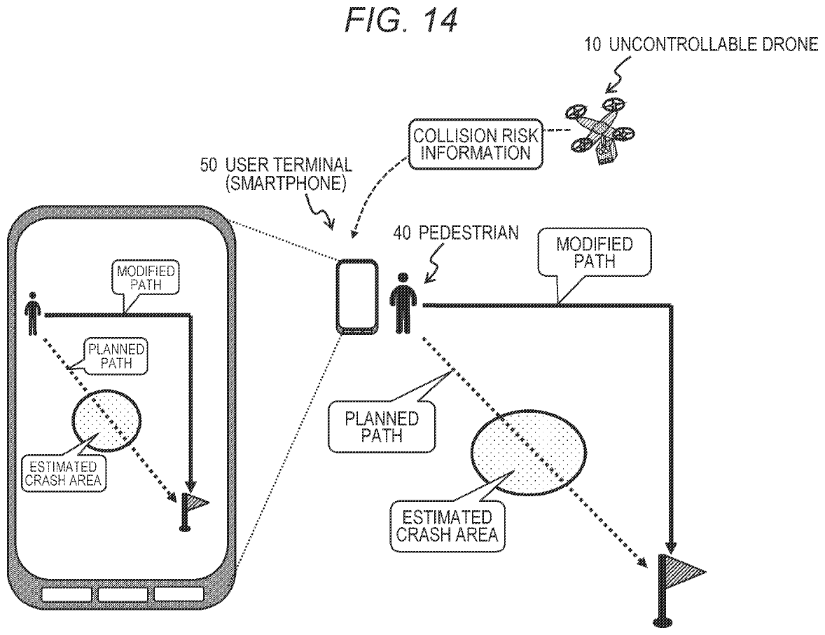

For example, as illustrated in FIG. 14, the information processing device 100 of the uncontrollable drone 10 broadcasts the warning information to the communication terminal, which is a smartphone for example, near the “estimated crash area”. Specifically, for example, the warning information is transmitted to a user terminal in the estimated crash area or in a range of about 30 m around the estimated crash area.

Upon receiving the warning information, the user terminal 50 such as a smartphone analyzes the received information in response to the reception of the collision risk information from the drone, generates, on the basis of an analysis result, a modified path avoiding the estimated crash area, and displays the modified path on the user terminal 50.

It is assumed that a planned path of the user (pedestrian 40) is input to the user terminal 50 in advance. Furthermore, it is assumed that an application (program) is installed in advance, the application being configured to analyze received information in response to reception of collision risk information from a drone, execute map analysis processing or the like on the basis of an analysis result, and generate and display a modified path avoiding the estimated crash area.

For example, the pedestrian 40 illustrated in FIG. 14 can confirm the modified path displayed on the user terminal 50 and head to a destination according to the modified path avoiding the estimated crash area of the drone.

Note that, also in the present example, processing similar to the processing by the user terminal (smartphone) 50 can be performed by using a communication terminal of a car.

Note that, although the example illustrated in FIG. 14 is an example of processing in which the application (program) in the user terminal 50 performs processing of generating the modified path, for example, the drone management server 30 may generate a modified path and transmit the modified path to the user terminal 50.

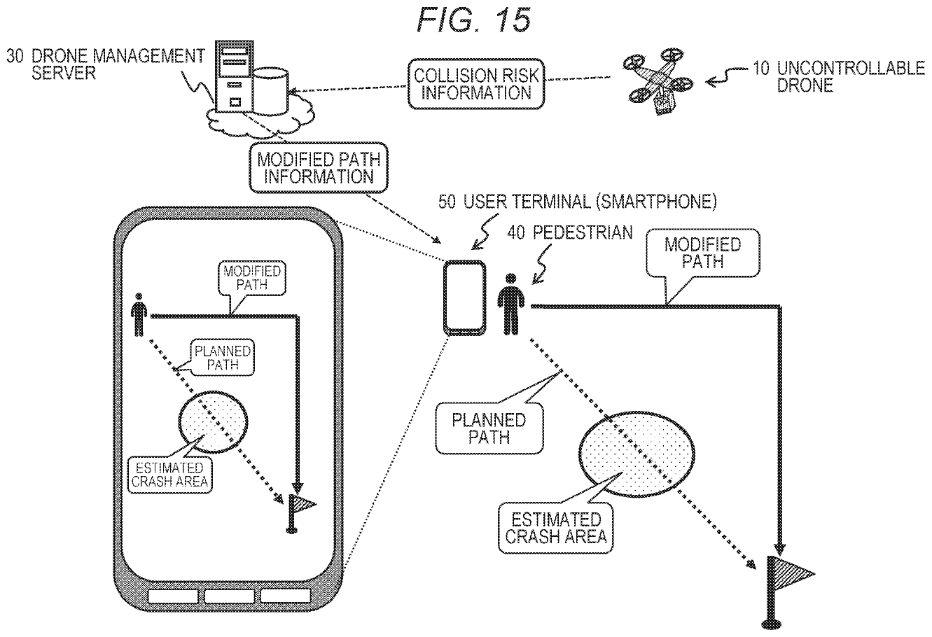

This configuration example will be described with reference to FIG. 15.

As illustrated in FIG. 15, the uncontrollable drone 10 transmits the collision risk information generated by the uncontrollable drone 10 to the drone management server 30.

The drone management server 30 receives the collision risk information from the uncontrollable drone 10, generates a modified safe path corresponding to each user terminal position, for a communication terminal, which is a smartphone for example, near the “estimated crash area” on the basis of the received collision risk information, and transmits the generated modified safe path to each user terminal.

Note that the drone management server 30 receives position information from the user terminal, and generates, on the basis of the received position information, a modified path corresponding to each user terminal, that is, a modified safe path avoiding the estimated crash area.

The drone management server 30 transmits the generated modified path information to each user terminal.

On the display unit of the user terminal 50, the user terminal 50 displays the modified path received from the drone management server 30.

For example, the pedestrian 40 illustrated in FIG. 15 can confirm the modified path displayed on the user terminal 50 and head to a destination according to the modified path avoiding the estimated crash area of the drone. Note that, also in the present example, processing similar to the processing by the user terminal (smartphone) 50 can be performed by using a communication terminal of a car.

[4. Embodiment for Displaying Warning Information or the Like on Controller of Controllable Drone]

Next, an embodiment for displaying warning information or the like on a controller of a controllable drone will be described.

The embodiment described below is an embodiment in which, for example, in a case where a flight of the controllable drone 20 is under control of the user holding a controller, a collision risk area or the like of the uncontrollable drone 10 is displayed on the controller of the user.

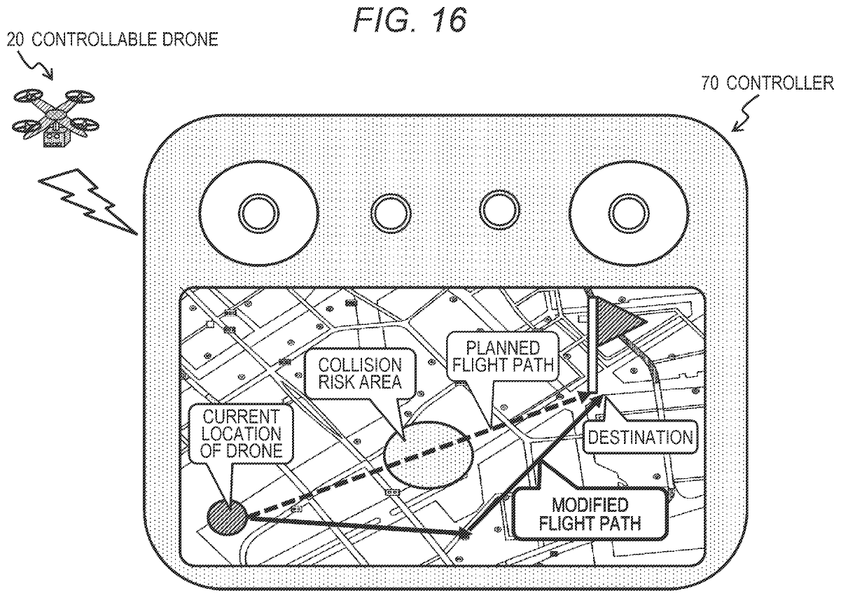

The controller 70 illustrated in FIG. 16 is a controller of the controllable drone 20, and a flight of the controllable drone 20 is under control of operation of a controller 70 by the user.

The controller 70 has a display unit, and on the display unit, displays display data similar to the display data on the user terminal 50 described above with reference to FIGS. 14 and 15.

For example, the information processing device 100 of the uncontrollable drone 10 broadcasts warning information to the controller 70 that is a communication terminal near the “estimated crash area”. Specifically, for example, the warning information is transmitted to a controller in the estimated crash area or in a range of about 30 m around the estimated crash area.

Upon receiving the warning information, the controller 70 analyzes the received information in response to the reception of the collision risk information from the drone, generates, on the basis of an analysis result, a modified flight path avoiding the collision risk area, and displays the modified flight path on the display unit of the controller 70.

It is assumed that a planned flight path of the controllable drone 20 is input to the controller 70 in advance. Furthermore, it is assumed that an application (program) is installed in advance, the application being configured to analyze received information in response to reception of collision risk information from a drone, execute map analysis processing or the like on the basis of an analysis result, and generate and display a modified flight path avoiding the collision risk area.

For example, the user who has checked the display data illustrated in FIG. 16, that is, an operator of the controller 70, can confirm the modified flight path displayed on the controller 70, and allows a flight according to the modified flight path avoiding the collision risk area.

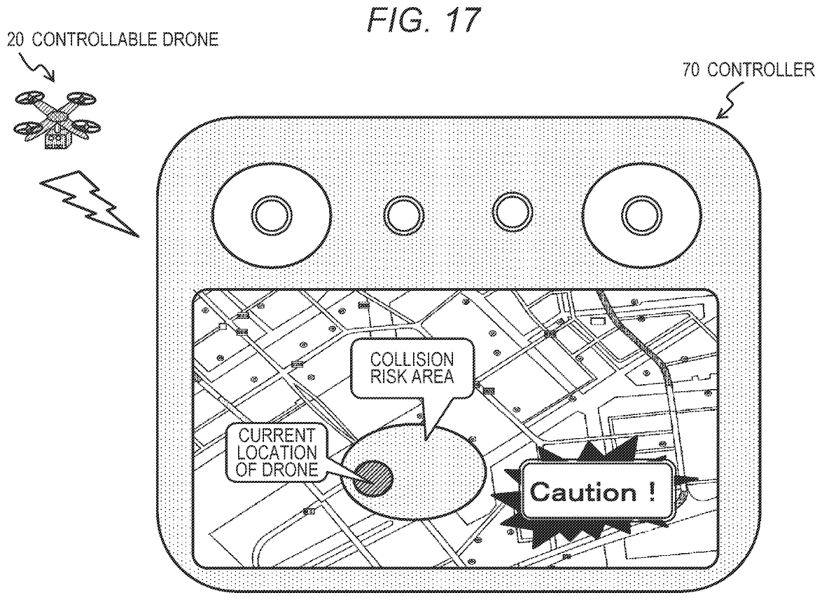

Note that, for example, in a case where the controllable drone 20 has already entered the collision risk area, warning information may be displayed on the display unit of the controller 70, as illustrated in FIG. 17.

This warning display is also executed by the application (program) installed on the controller 70.

For example, the user who has checked the display data illustrated in FIG. 17, that is, the operator of the controller 70, can confirm the display data on the controller 70, and operate the controller 70 so as to be away from the collision risk area.

[5. Sequences of Processing Executed by Information Processing Device According to Present Disclosure]

Next, sequences of processing executed by the information processing device according to the present disclosure will be described.

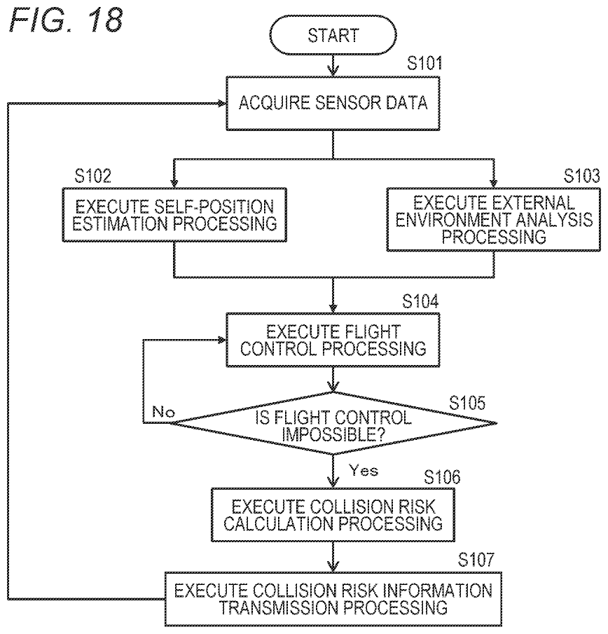

Sequences of processing executed by the information processing device according to the present disclosure will be described with reference to flowcharts illustrated in FIG. 18 and subsequent drawings.

Note that the information processing device according to the present disclosure includes, for example, the drone management server 30 illustrated in FIG. 8, the user terminal 50 illustrated in FIG. 12, and the controller 70 illustrated in FIG. 16 in addition to the information processing device mounted on the drone.

Hereinafter, sequences of processing executed by these information processing devices will be described.

Note that the following processing sequences of the respective devices will be sequentially described with reference to flowcharts in FIGS. 18 to 23.

(1) Processing sequence executed by information processing device of uncontrollable drone (FIG. 18)

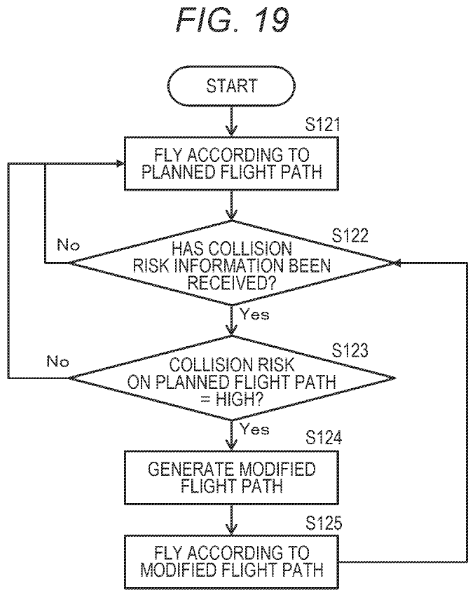

(2) Processing sequence executed by information processing device of controllable drone (FIG. 19)

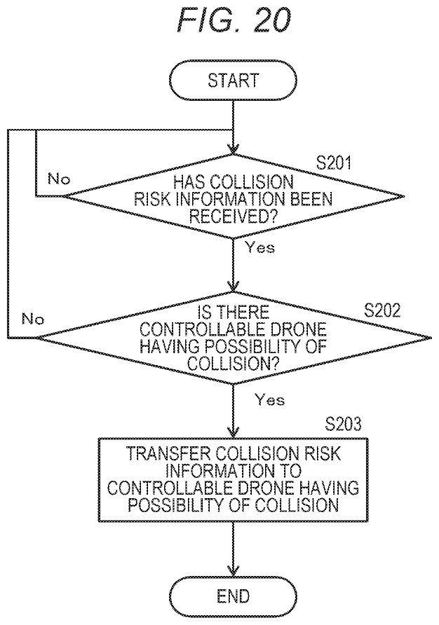

(3) Processing sequence executed by drone management server (FIG. 20)

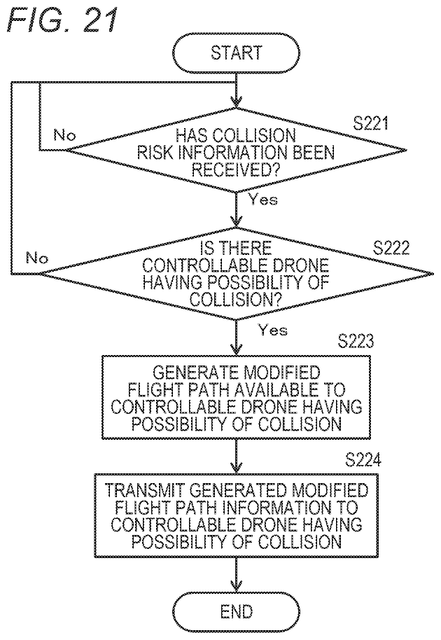

(4) Processing sequence executed by drone management server (FIG. 21)

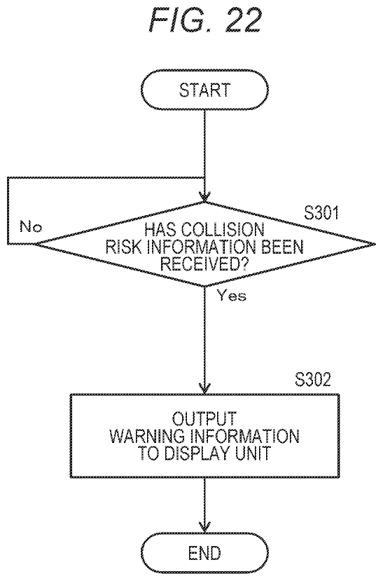

(5) Processing sequence executed by user terminal or controller (FIG. 22)

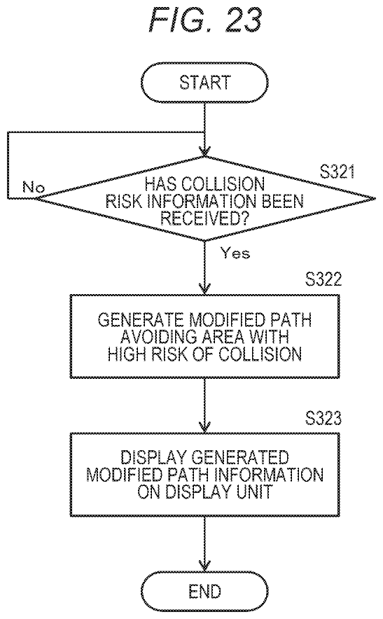

(6) Processing sequence executed by user terminal or controller (FIG. 23)

Hereinafter, these processing sequences will be sequentially described.

(1) Processing Sequence Executed by Information Processing Device of Uncontrollable Drone (FIG. 18)

First, a processing sequence executed by the information processing device 100 mounted on the uncontrollable drone 10 will be described with reference to the flowchart illustrated in FIG. 18.

Note that the processing according to the flowchart in FIG. 18 and the subsequent drawings is processing that can be executed, according to a program stored in a memory inside the information processing device, under control of a control unit (data processing unit) including a CPU or the like that has a function of executing a program in the information processing device.

Hereinafter, the processing in each step of the flows described in FIG. 18 and subsequent drawings will be described.

(Step S101)

First, the data processing unit of the information processing device 100 mounted on the uncontrollable drone 10 acquires sensor data in Step S101.

The drone is equipped with various sensors including a camera that acquires a position, flight direction, speed, and flight state of the drone, surrounding environment information, and the like, and the data processing unit inputs these various pieces of sensor-detected information.

(Step S102)

The processing in Step S102 and the processing in Step S103 can be executed in parallel.

In Step S102, the data processing unit executes self-position estimation processing.

The self-position estimation processing is executed by, for example, processing utilizing GPS position information serving as sensor-acquired information, simultaneous localization and mapping (SLAM) processing utilizing an image captured by a camera that constitutes a sensor, or the like.

The SLAM processing is processing of estimating a three-dimensional position of a characteristic point by capturing an image (moving image) with a camera and analyzing a locus of the characteristic point included in a plurality of captured images, and of estimating a position and orientation (localization) of the camera (self), and the SLAM processing is capable of creating (mapping) a surrounding map (environmental map) by using three-dimensional position information of the characteristic point. Thus, the processing of executing position identification (localization) of the camera (self) and creation (mapping) of the surrounding map (environmental map) in parallel is called SLAM.

(Step S103)

In Step S103, the data processing unit analyzes external environmental information on the basis of the sensor-acquired information.

For example, external environmental information such as wind strength and direction is analyzed.

(Step S104)

Next, in Step S104, the data processing unit executes control of a flight of the drone.

On the basis of a self-position acquired in Step S102 and the external environmental information acquired in Step S103, the data processing unit generates a drive control signal for the drone to go to a preset destination, and outputs the generated drive control signal to a drive unit of the drone to execute flight control.

Note that there may be a case where, for example, a control signal from a drone management server or a control signal from a controller is utilized for this flight control.

(Step S105)

Next, in Step S105, the data processing unit determines whether or not the flight control has become impossible.

In a case where the flight control has not become impossible, the flight control in Step S104 is continued.

Meanwhile, in a case where it is determined that the flight control has become impossible, the processing proceeds to Step S106.

(Step S106)

In a case where it is determined in Step S105 that the control of the flight of the drone has become impossible, the processing proceeds to Step S106.

In Step S106, the data processing unit executes processing of calculating a collision risk.

The collision risk is, for example, the collision risk described above with reference to FIG. 2 or the collision risk described above with reference to FIGS. 3 to 5.

In a case where the collision risk described with reference to FIG. 2 is calculated, a separation distance of an uncontrollable drone from the predicted flight path is calculated.

That is, a separation distance from the predicted flight path of the uncontrollable drone is calculated for each point (x, y, z) in the three-dimensional space, and the separation distances are calculated as collision risk information of the respective points (x, y, z) in the three-dimensional space.

Furthermore, in a case where a collision risk described with reference to FIGS. 3 to 5 is calculated, a collision probability at each spatial position in the areas around the estimated airframe position at each time is calculated on the basis of a result of estimation of airframe positions after t1 to tn seconds from the current time. Moreover, for example, an area with a high collision probability, for example, an area in which the probability of collision is 90% or more is calculated, and this area information is calculated as a collision risk.

In Step S106, the data processing unit calculates, for example, either one of the collision risk information described above, that is, either

(a) Collision risk information represented by a separation distance from the predicted flight path of the uncontrollable drone at each position in the three-dimensional space, or

(b) Collision risk information including information of an area with a high collision probability, for example, information of an area with collision probability=90% or more.

(Step S107)

Finally, in Step S107, the data processing unit transmits the collision risk information calculated in Step S106.

The collision risk information is transmitted to another controllable drone, a drone management server, a user terminal, a controller of another controllable drone, or the like.

Note that, after the transmission of the collision risk information in Step S107, the processing returns to Step S101, and the processing in Step S101 and subsequent steps is repeated.

In a case where the collision risk information is updated, the last updated collision risk information is transmitted to an external device, for example, a controllable drone or the like.

(2) Processing Sequence Executed by Information Processing Device of Controllable Drone (FIG. 19)

Next, a processing sequence executed by an information processing device of a controllable drone will be described with reference to the flowchart illustrated in FIG. 19.

(Step S121)

First, in Step S121, the data processing unit of the information processing device 120 mounted on the controllable drone 20 flies according to the planned flight path.

Note that, although not described in this flow, the controllable drone 20 also flies while executing processing similar to the processing in Steps S101 to S103 described with reference to FIG. 19.

That is, for the flight, self-position estimation processing based on sensor-acquired information and external environment analysis processing are performed, a drive control signal of the drone is generated on the basis of these analysis results, and the generated drive control signal is output to the drive unit of the drone.

(Step S122)

Next, in Step S121, the data processing unit of the information processing device 120 of the controllable drone 20 determines whether or not collision risk information has been received.

The collision risk information is received from the uncontrollable drone or a drone management server.

In a case where it is determined in Step S122 that the collision risk information has been received, the processing proceeds to Step S123.

Meanwhile, in a case where it is determined in Step S122 that the collision risk information has not been received, the processing returns to Step S121, and a flight according to the planned flight path is continued.

(Step S123)

In a case where it is determined in Step S122 that the collision risk information has been received, the processing proceeds to Step S123.

In Step S123, the data processing unit of the information processing device 120 of the controllable drone 20 determines whether or not a current planned flight path is planned to pass through an area with a high collision risk.

For example, it is determined whether or not an area with Collision probability=90% will be passed through.

In a case where it is determined that the current planned flight path is planned to pass through the area with a high collision risk, the processing proceeds to Step S124.

Meanwhile, in a case where it is determined that the current planned flight path is not planned to pass through the area with a high collision risk, the processing returns to Step S121, and a flight according to the planned flight path is continued.

(Step S124)

In a case where it is determined in Step S123 that the current planned flight path is planned to pass through the area with a high collision risk, the processing proceeds to Step S124.

In Step S124, the data processing unit of the information processing device 120 of the controllable drone 20 generates a modified flight path.

That is, a modified safe flight path that does not pass through an area with a high collision risk is generated.

(Step S125)

Finally, in Step S125, a flight according to the modified flight path generated in Step S124 is performed.

Through these pieces of processing, the controllable drone can fly by utilizing a safe flight path with a low probability of collision with an uncontrollable drone.

(3) Processing Sequence Executed by Drone Management Server (FIG. 20)

Next, a processing sequence executed by a drone management server will be described with reference to a flowchart illustrated in FIG. 20.

(Step S201)

First, in Step S201, the drone management server 30 determines whether or not collision risk information has been received.

The collision risk information is received from an uncontrollable drone.

In a case where it is determined in Step S201 that the collision risk information has been received, the processing proceeds to Step S202.

Meanwhile, in a case where it is determined in Step S201 that the collision risk information has not been received, the processing returns to Step S201.

(Step S202)

In a case where it is determined in Step S201 that the collision risk information has been received, the processing proceeds to Step S202.

In Step S202, the drone management server 30 analyzes the received collision risk information, and determines whether or not there is a drone having a possibility of collision, such as a controllable drone that flies at a position close to an area with a high collision risk, or a controllable drone of which planned flight path includes an area with a high collision risk.

In a case where existence of a drone having a possibility of collision is confirmed, the processing proceeds to Step S203.

Meanwhile, in a case where the existence of the drone having a possibility of collision is not confirmed, the processing returns to Step S201.

(Step S203)

In a case where the existence of the drone having a possibility of collision is confirmed in Step S202, the processing proceeds to Step S203.

In Step S203, the drone management server 30 transfers the collision risk information received in Step S201 to the controllable drone having a possibility of collision.

That is, in Step S201, the collision risk information received from the uncontrollable drone is transmitted to the controllable drone having a possibility of collision.

The controllable drone that has received the collision risk information can execute the processing described above with reference to FIG. 19, generate a modified safe flight path, and fly according to the modified flight path.

(4) Processing Sequence Executed by Drone Management Server (FIG. 21)

Next, another processing sequence executed by a drone management server, that is, a processing sequence different from the flow illustrated in FIG. 20 will be described with reference to the flowchart illustrated in FIG. 21.

(Step S221)

First, in Step S221, the drone management server 30 determines whether or not collision risk information has been received.

The collision risk information is received from an uncontrollable drone.

In a case where it is determined in Step S221 that the collision risk information has been received, the processing proceeds to Step S222.

Meanwhile, in a case where it is determined in Step S221 that the collision risk information has not been received, the processing returns to Step S221.

(Step S222)

In a case where it is determined in Step S221 that the collision risk information has been received, the processing proceeds to Step S222.

In Step S222, the drone management server 30 analyzes the received collision risk information, and determines whether or not there is a drone having a possibility of collision, such as a controllable drone that flies at a position close to an area with a high collision risk, or a controllable drone of which planned flight path includes an area with a high collision risk.

In a case where existence of a drone having a possibility of collision is confirmed, the processing proceeds to Step S223.

Meanwhile, in a case where the existence of the drone having a possibility of collision is not confirmed, the processing returns to Step S221.

(Step S223)

In a case where the existence of the drone having a possibility of collision is confirmed in Step S222, the processing proceeds to Step S223.

In Step S223, the drone management server 30 generates a modified flight path available to a controllable drone having a possibility of collision.

That is, the collision risk information received from the uncontrollable drone in Step S221 is analyzed to generate a modified safe flight path avoiding an area with a high risk of collision.

(Step S224)

Next, in Step S224, the drone management server 30 transmits the modified flight path information generated in Step S223 to the controllable drone having a possibility of collision.

The controllable drone that has received the modified flight path information can fly safely according to the modified flight path.

(5) Processing Sequence Executed by User Terminal or Controller (FIG. 22)

Next, a processing sequence executed by a user terminal or a controller will be described with reference to the flowchart illustrated in FIG. 22.

That is, for example, the processing sequence is executed by the user terminal 50 illustrated in FIG. 12 or the controller 70 illustrated in FIG. 16.

(Step S301)

First, in Step S301, the user terminal 50 or the controller 70 determines whether or not collision risk information has been received.

The collision risk information is received from the uncontrollable drone or a drone management server.

In a case where it is determined in Step S301 that the collision risk information has been received, the processing proceeds to Step S302.

Meanwhile, in a case where it is determined in Step S301 that the collision risk information has not been received, the determination processing in Step S301 is continued.

(Step S302)

In a case where it is determined in Step S301 that the collision risk information has been received, the processing proceeds to Step S302.

In Step S302, the user terminal 50 or the controller 70 outputs warning information to a display unit on the basis of the received collision risk information.

For example, warning information as illustrated in FIGS. 12 and 17 is output.

(6) Processing Sequence Executed by User Terminal or Controller (FIG. 23)

Next, another processing sequence executed by a user terminal or a controller will be described with reference to the flowchart illustrated in FIG. 23.

(Step S321)

First, in Step S321, the user terminal 50 or the controller 70 determines whether or not collision risk information has been received.

The collision risk information is received from the uncontrollable drone or a drone management server.

In a case where it is determined in Step S321 that the collision risk information has been received, the processing proceeds to Step S322.

Meanwhile, in a case where it is determined in Step S321 that the collision risk information has not been received, the determination processing in Step S321 is continued.

(Step S322)

In a case where it is determined in Step S321 that the collision risk information has been received, the processing proceeds to Step S322.

In Step S322, the user terminal 50 or the controller 70 analyzes the collision risk information received in Step S321, and generates a modified safe path avoiding an area with a high risk of collision.

(Step S323)

Next, in Step S323, the user terminal 50 or the controller 70 outputs the modified path generated in Step S322 to the display unit.

For example, the modified path information as illustrated in FIGS. 14 and 16 is output.

The user holding the user terminal 50 can avoid a collision with the uncontrollable drone by proceeding according to the modified path displayed on the user terminal 50.

Furthermore, the user who controls the controllable drone by using the controller 70 can avoid collision between the controllable drone and the uncontrollable drone by controlling the controllable drone to fly along the modified path displayed on the controller 70.

Note that, although an embodiment in which the mobile object is a drone has been described in the above-described embodiment, as described above, the information processing device according to the present disclosure can be utilized by being mounted on another mobile object, for example, a robot or an autonomous driving vehicle, not limited to a drone.

Similar processing can be performed by replacing the drone in the above-described embodiment with the robot or autonomous driving vehicle.

[6. Configuration Example of Information Processing Device]

Next, a configuration example of the information processing device will be described.

Note that, as described above, the information processing device according to the present disclosure includes, for example, the drone management server 30 illustrated in FIG. 8, the user terminal 50 illustrated in FIG. 12, and the controller 70 illustrated in FIG. 16 in addition to the information processing device mounted on the drone.

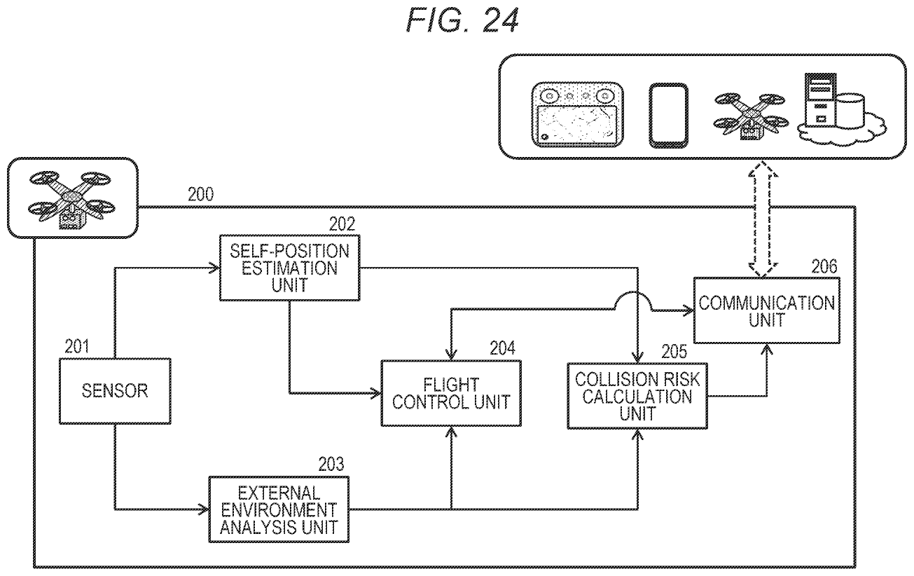

First, a configuration example of the information processing device mounted on a drone will be described with reference to FIG. 24.

FIG. 24 is a block diagram illustrating a configuration example of the information processing device mounted the drone.

Note that the block diagram of an information processing device 200 illustrated in FIG. 24 is a block diagram illustrating only main components that are applied to processing according to the present disclosure and are extracted from the configuration of the information processing device mounted on the drone.

As illustrated in FIG. 24, the information processing device 200 mounted on the drone includes a sensor 201, a self-position estimation unit 202, an external environment analysis unit 203, a flight control unit 204, a collision risk calculation unit 205, and a communication unit 206.

Each of the components will be described.

The sensor 201 includes various sensors including a camera that acquires a position, flight direction, speed, and flight state of the drone, surrounding environment information, and the like.

The information acquired by the sensor 201 including these various sensors is input to the self-position estimation unit 202 and the external environment analysis unit 203.

The self-position estimation unit 202 executes, for example, processing of estimating a self-position by using processing utilizing GPS position information serving as sensor-acquired information, simultaneous localization and mapping (SLAM) processing utilizing an image captured by a camera that constitutes a sensor, or the like.

The external environment analysis unit 203 executes analysis of information of external environment, such as wind speed and wind direction for example, by using the sensor-acquired information.

The flight control unit 204 executes flight control of the drone.

On the basis of the self-position estimation information input from the self-position estimation unit 202 or the external environmental information input from the external environment analysis unit 203, the flight control unit 204 generates a drive control signal for the drone to go to a preset destination, and outputs the generated drive control signal to a drive unit of the drone to execute flight control.

Note that there may be a case where, for example, a control signal from a drone management server or a control signal from a controller is utilized for this flight control.

The collision risk calculation unit 205 executes processing of calculating a collision risk of the drone.

The collision risk calculation unit 205 calculates the collision risk described above with reference to FIG. 2 or the collision risk described above with reference to FIGS. 3 to 5, for example.

In a case where the collision risk described with reference to FIG. 2 is calculated, a separation distance of an uncontrollable drone from the predicted flight path is calculated.

That is, a separation distance from the predicted flight path of the uncontrollable drone is calculated for each point (x, y, z) in the three-dimensional space, and the separation distances are calculated as collision risk information of the respective points (x, y, z) in the three-dimensional space.

Furthermore, in a case where a collision risk described with reference to FIGS. 3 to 5 is calculated, a collision probability at each spatial position in the areas around the estimated airframe position at each time is calculated on the basis of a result of estimation of airframe positions after t1 to tn seconds from the current time. Moreover, for example, an area with a high collision probability, for example, an area in which the probability of collision is 90% or more is calculated, and this area information is calculated as a collision risk.

The communication unit 206 executes communication with an external controllable drone or an external device such as a drone management server, a user terminal, or a controller.

For example, the collision risk calculated by the collision risk calculation unit 205 is transmitted to these external devices.

Furthermore, in a case of a controllable drone, flight control information is received from the controller, the drone management server, or the like, the received flight control information is input to the flight control unit 204, and the flight control unit 204 performs flight according to the received information.

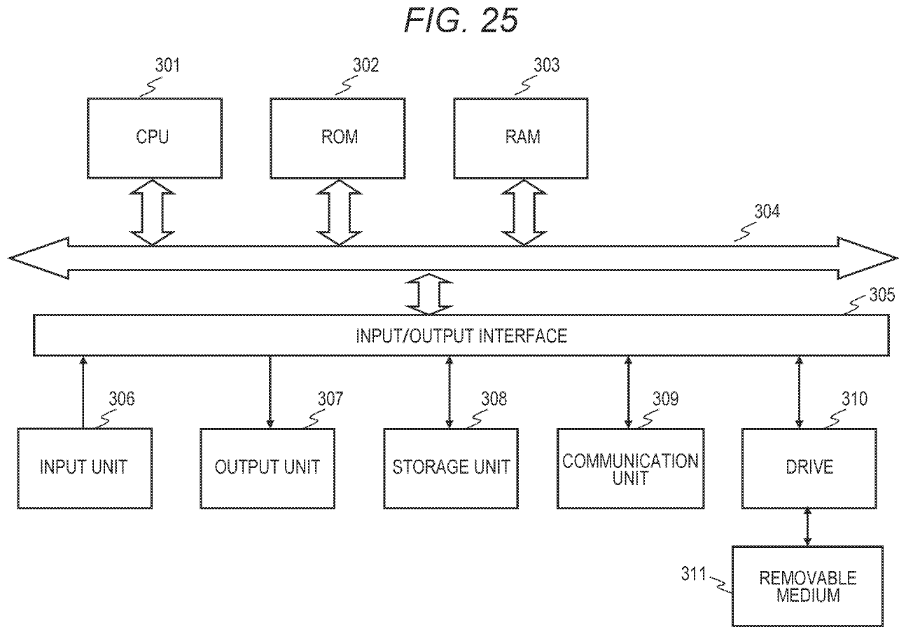

Next, with reference to FIG. 25, there is described an example of a hardware configuration commonly available to the information processing device mounted on the drone, the drone management server 30 illustrated in FIG. 8, the user terminal 50 illustrated in FIG. 12, and the controller 70 illustrated in FIG. 16, which are information processing devices according to the present disclosure.

A central processing unit (CPU) 301 functions as a data processing unit that executes various kinds of processing according to a program stored in a read only memory (ROM) 302 or a storage unit 308. For example, processing according to a sequence described in the above-described embodiment is executed. A random access memory (RAM) 303 stores a program, data, or the like executed by the CPU 301. The CPU 301, the ROM 302, and the RAM 303 are mutually connected by a bus 304.

The CPU 301 is connected to an input/output interface 305 via the bus 304, and the input/output interface 305 is connected to an input unit 306 including various kinds of sensors, a camera, a switch, a keyboard, a mouse, a microphone, or the like, and to an output unit 307 including a display, a speaker, or the like.

The storage unit 308 connected to the input/output interface 305 includes, for example, a USB memory, an SD card, a hard disk, or the like, and stores a program executed by the CPU 301 or various kinds of data. A communication unit 309 functions as a transmission/reception unit for data communication via a network such as the Internet or a local area network, and communicates with an external device.

A drive 310 connected to the input/output interface 305 drives a removable medium 311 such as a magnetic disk, an optical disc, a magneto-optical disk, or a semiconductor memory such as a memory card, and records or reads data.

[7. Conclusion of Configuration According to Present Disclosure]

Hereinabove, the embodiment according to the present disclosure have been described in detail with reference to the specific embodiment. However, it is obvious that those skilled in the art may make modifications or substitutions to the embodiment without departing from the scope of the present disclosure. That is to say, the present invention has been disclosed in a form of exemplification, and should not be interpreted to be limited. In order to determine the scope of the present disclosure, the claims should be taken into consideration.

Note that the technology disclosed in the present specification can have the following configurations.

(1) An information processing device including a data processing unit that

checks, on the basis of collision risk information received from a first mobile device, existence of a second mobile device exposed to a collision risk, and,

in a case where the existence of the second mobile device exposed to the collision risk is confirmed,

transmits, to the second mobile device exposed to the collision risk, the collision risk information received from the first mobile device.

(2) The information processing device according to (1),

in which the first mobile device includes a first drone, and

the data processing unit

transmits, to a second drone exposed to a risk of collision with the first drone, collision risk information received from the first drone.

(3) The information processing device according to (1) or (2),

in which the data processing unit

generates, on the basis of the collision risk information received from the first mobile device, a modified safe path of the second mobile device exposed to the collision risk, and

transmits the generated modified path to the second mobile device.

(4) The information processing device according to any one of (1) to (3),

in which the data processing unit

checks, on the basis of the collision risk information received from the first mobile device, existence of a pedestrian on ground, the pedestrian being exposed to a collision risk, and,

in a case where the existence of the pedestrian exposed to the collision risk is confirmed,

transmits, to a communication terminal near the collision risk, the collision risk information received from the first mobile device, or warning information.

(5) The information processing device according to any one of (1) to (4),

in which the data processing unit

checks, on the basis of the collision risk information received from the first mobile device, existence of a pedestrian on ground, the pedestrian being exposed to a collision risk, and,

in a case where the existence of the pedestrian exposed to the collision risk is confirmed,

generates a modified safe path of the pedestrian exposed to the collision risk, and

transmits the generated modified path to a communication terminal near the collision risk.

(6) The information processing device according to any one of (1) to (5),

in which the data processing unit

checks, on the basis of the collision risk information received from the first mobile device, existence of a second mobile device exposed to a collision risk, and,

in a case where the existence of the second mobile device exposed to the collision risk is confirmed,

transmits, to a controller near the collision risk, the collision risk information received from the first mobile device, warning information, or modified path information.

(7) The information processing device according to any one of (1) to (6),

in which collision risk information received from the first mobile device

includes data of separation distance from a predicted path of the first mobile device, the separation distance corresponding to each three-dimensional spatial position.

(8) The information processing device according to any one of (1) to (6),

in which collision risk information received from the first mobile device

includes area information indicating an area with a high probability of a collision of the first mobile device.

(9) The information processing device according to (8), in which the area information includes area information generated with Bayesian inference processing using a sequential Bayesian filter.

(10) An information processing device mounted on a drone,

in which a data processing unit

generates collision risk information corresponding to each three-dimensional spatial position as collision risk information of the drone, and

transmits the generated collision risk information to an external device.

(11) The information processing device according to (10), in which the external device includes a second drone, a drone management server, a user terminal, or a controller of the second drone.

(12) The information processing device according to (10) or (11),

in which collision risk information calculated by the data processing unit

includes data of separation distance from a predicted flight path of the first drone, the separation distance corresponding to each three-dimensional spatial position.

(13) The information processing device according to any one of (10) to (12),

in which collision risk information calculated by the data processing unit

includes area information indicating an area with a high probability of a collision of the drone.

(14) An information processing device mounted on a drone, the information processing device including a data processing unit that

generates, on the basis of collision risk information received from an uncontrollable drone, a modified safe flight path with a low collision risk, and

executes flight control according to the generated modified flight path.

(15) The information processing device according to (14), in which the modified flight path includes a flight path avoiding an area with a high collision risk.

(16) An information processing method executed in an information processing device, the information processing method including,

by a data processing unit,

checking, on the basis of collision risk information received from a first mobile device, existence of a second mobile device exposed to a collision risk, and,

in a case where the existence of the second mobile device exposed to the collision risk is confirmed,

transmitting, to the second mobile device exposed to the collision risk, the collision risk information received from the first mobile device.

(17) An information processing method executed in an information processing device mounted on a drone, the information processing method including,

by a data processing unit,

generating collision risk information corresponding to each three-dimensional spatial position as collision risk information of the drone, and

transmitting the generated collision risk information to an external device.

(18) An information processing method executed in an information processing device mounted on a drone, the information processing method including,

by a data processing unit,

generating, on the basis of collision risk information received from an uncontrollable drone, a modified safe flight path with a low collision risk, and

executing flight control according to the generated modified flight path.

(19) A program causing information processing to be executed in an information processing device, the program causing a data processing unit to execute processing of

checking, on the basis of collision risk information received from a first mobile device, existence of a second mobile device exposed to a collision risk, and,

in a case where the existence of the second mobile device exposed to the collision risk is confirmed,

transmitting, to the second mobile device exposed to the collision risk, the collision risk information received from the first mobile device.

(20) A program causing information processing to be executed in an information processing device mounted on a drone, the program causing a data processing unit to execute processing of

generating collision risk information corresponding to each three-dimensional spatial position as collision risk information of the drone, and

transmitting the generated collision risk information to an external device.

Furthermore, the series of processing described in the specification can be executed by hardware, software, or a combined configuration of both. In a case where processing is executed by software, it is possible to install a program in which a processing sequence is recorded, on a memory in a computer incorporated in dedicated hardware and execute the program, or it is possible to install and execute the program on a general-purpose personal computer that is capable of executing various kinds of processing. For example, the program can be previously recorded on a recording medium. In addition to installation from the recording medium to the computer, the program can be received via a network such as a local area network (LAN) or the Internet and installed on a recording medium such as a built-in hard disk.

Note that the various kinds of processing described in the specification may be executed not only in time series according to the description but also in parallel or individually, according to processing capability of a device that executes the processing, or as necessary. Furthermore, in the present specification, a system is a logical set configuration of a plurality of devices, and is not limited to a system in which devices of respective configurations are in the same housing.

### INDUSTRIAL APPLICABILITY

As described above, according to a configuration of an embodiment according to the present disclosure, a configuration is achieved in which collision risk information is received from a mobile device such as a drone, a modified path with a low collision risk is generated, and movement according to the modified path is performed.

Specifically, for example, existence of a second mobile device or pedestrian exposed to a collision risk is checked on the basis of collision risk information received from the mobile device such as a drone, and in a case where the existence of the second mobile device or pedestrian exposed to the collision risk is confirmed, collision risk information received from the first mobile device or modified safe circuit information is transmitted to the second mobile device exposed to the collision risk, or transmitted to a user terminal held by the pedestrian exposed to the collision risk. The collision risk information received from the mobile device such as a drone is risk information with which a collision risk corresponding to a three-dimensional spatial position can be analyzed.

With this configuration, a configuration is achieved in which collision risk information is received from a mobile device such as a drone, a modified path with a low collision risk is generated, and movement according to the modified path is performed.

REFERENCE SIGNS LIST

| | |
|---|---|
| 10 | Uncontrollable drone |
| 20 | Controllable drone |
| 30 | Drone management server |
| 50 | User terminal |
| 70 | Controller |
| 100, 120 | Information processing device |
| 200 | Information processing device |
| 201 | Sensor |
| 202 | Self-position estimation unit |
| 203 | External environment analysis unit |
| 204 | Flight control unit |
| 205 | Collision risk calculation unit |
| 206 | Communication unit |
| 301 | CPU |
| 302 | ROM |
| 303 | RAM |
| 304 | Bus |
| 305 | Input/output interface |
| 306 | Input unit |
| 307 | Output unit |
| 308 | Storage unit |
| 309 | Communication unit |
| 310 | Drive |
| 311 | Removable medium |

1. An information processing device comprising a data processing unit that
checks, on a basis of collision risk information received from a first mobile device, existence of a second mobile device exposed to a collision risk, and,
in a case where the existence of the second mobile device exposed to the collision risk is confirmed,
transmits, to the second mobile device exposed to the collision risk, the collision risk information received from the first mobile device.

2. The information processing device according to claim 1,
wherein the first mobile device includes a first drone, and
the data processing unit
transmits, to a second drone exposed to a risk of collision with the first drone, collision risk information received from the first drone.

3. The information processing device according to claim 1,
wherein the data processing unit
generates, on a basis of the collision risk information received from the first mobile device, a modified safe path of the second mobile device exposed to the collision risk, and
transmits the generated modified path to the second mobile device.

4. The information processing device according to claim 1,
wherein the data processing unit
checks, on a basis of the collision risk information received from the first mobile device, existence of a pedestrian on ground, the pedestrian being exposed to a collision risk, and,
in a case where the existence of the pedestrian exposed to the collision risk is confirmed,
transmits, to a communication terminal near the collision risk, the collision risk information received from the first mobile device, or warning information.

5. The information processing device according to claim 1,
wherein the data processing unit
checks, on a basis of the collision risk information received from the first mobile device, existence of a pedestrian on ground, the pedestrian being exposed to a collision risk, and,
in a case where the existence of the pedestrian exposed to the collision risk is confirmed,
generates a modified safe path of the pedestrian exposed to the collision risk, and
transmits the generated modified path to a communication terminal near the collision risk.

6. The information processing device according to claim 1,
wherein the data processing unit
checks, on a basis of the collision risk information received from the first mobile device, existence of a second mobile device exposed to a collision risk, and,
in a case where the existence of the second mobile device exposed to the collision risk is confirmed,
transmits, to a controller near the collision risk, the collision risk information received from the first mobile device, warning information, or modified path information.

7. The information processing device according to claim 1,
wherein collision risk information received from the first mobile device
includes data of separation distance from a predicted path of the first mobile device, the separation distance corresponding to each three-dimensional spatial position.

8. The information processing device according to claim 1,
wherein collision risk information received from the first mobile device
includes area information indicating an area with a high probability of a collision of the first mobile device.

9. The information processing device according to claim 8, wherein the area information includes area information generated with Bayesian inference processing using a sequential Bayesian filter.

10. An information processing device mounted on a drone,
wherein a data processing unit
generates collision risk information corresponding to each three-dimensional spatial position as collision risk information of the drone, and
transmits the generated collision risk information to an external device.

11. The information processing device according to claim 10, wherein the external device includes a second drone, a drone management server, a user terminal, or a controller of the second drone.

12. The information processing device according to claim 10,
wherein collision risk information calculated by the data processing unit
includes data of separation distance from a predicted flight path of the first drone, the separation distance corresponding to each three-dimensional spatial position.

13. The information processing device according to claim 10,
wherein collision risk information calculated by the data processing unit
includes area information indicating an area with a high probability of a collision of the drone.

14. An information processing device mounted on a drone, the information processing device comprising a data processing unit that
generates, on a basis of collision risk information received from an uncontrollable drone, a modified safe flight path with a low collision risk, and
executes flight control according to the generated modified flight path.

15. The information processing device according to claim 14, wherein the modified flight path includes a flight path avoiding an area with a high collision risk.

16. An information processing method executed in an information processing device, the information processing method comprising,
by a data processing unit:
checking, on a basis of collision risk information received from a first mobile device, existence of a second mobile device exposed to a collision risk, and,
in a case where the existence of the second mobile device exposed to the collision risk is confirmed,
transmitting, to the second mobile device exposed to the collision risk, the collision risk information received from the first mobile device.

17. An information processing method executed in an information processing device mounted on a drone, the information processing method comprising,
by a data processing unit:
generating collision risk information corresponding to each three-dimensional spatial position as collision risk information of the drone, and
transmitting the generated collision risk information to an external device.

18. An information processing method executed in an information processing device mounted on a drone, the information processing method comprising,
by a data processing unit:
generating, on a basis of collision risk information received from an uncontrollable drone, a modified safe flight path with a low collision risk, and
executing flight control according to the generated modified flight path.

19. A program causing information processing to be executed in an information processing device, the program causing a data processing unit to execute processing of:
checking, on a basis of collision risk information received from a first mobile device, existence of a second mobile device exposed to a collision risk, and,
in a case where the existence of the second mobile device exposed to the collision risk is confirmed,
transmitting, to the second mobile device exposed to the collision risk, the collision risk information received from the first mobile device.

20. A program causing information processing to be executed in an information processing device mounted on a drone, the program causing a data processing unit to execute processing of:
generating collision risk information corresponding to each three-dimensional spatial position as collision risk information of the drone, and
transmitting the generated collision risk information to an external device.
